(19) United States
(12) Patent Application Publication
(10) Pub. No.: US 2022/0284786 A1
(43) Pub. Date: Sep. 8, 2022

(54) UASTrakker - Emergency Radio Frequency Locator for Drones and Robots

(71) Applicant: Harlan Shawn Holmgren, Lake City, FL (US)

(72) Inventor: Harlan Shawn Holmgren, Lake City, FL (US)

(21) Appl. No.: 17/189,545

(22) Filed: Mar. 2, 2021

(51) Int. Cl. G08B 21/02; B64C 39/02; G08G 5/00

(52) U.S. Cl. CPC G08B 21/02; B64C 39/024; G08G 5/003; B64C 2201/145; B64C 2201/12

(57) ABSTRACT

Systems and methods for autonomous location of “Emergency Personal Locator Beacons” and other emergency Radio Frequency communication devices; providing navigation between Robotic systems such as a UAS, and the asset which is carrying a Personal Locator Beacon, EPIRB or signaling device which transmits a digital, ASCII or similar embedded data stream, intended for tracking and emergency location, within its RF broadcast. This method for navigating a robotic system or UAS relative to a defined target comprises detecting, on an Emergency Radio Frequency (RF) receiver an Emergency Radio Frequency signal generated by a Transmitter carried on the target, such as an Automatic Identification System Transmitter, As such there may be GPS enabled embedded data messages in these VHF radio transmissions, which is the focus of this invention. The invention decodes and parses the data contained in these messages, using proprietary software, converting them into motion commands for an autonomous robotic system.

### TECHNICAL FIELD

The present disclosure relates to robotic systems and Unmanned Aerial Vehicles (UAV) and, more particularly, to systems and methods for effectively and accurately navigating an Unmanned Ground Vehicle (UGV), Unmanned Surface Vehicle (USV) or an Unmanned Aerial Vehicle (UAV) relative to a moving person or asset which is using a commercially available emergency radio frequency Personal Locator Beacon (PLB) or emergency Radio Frequency (RF) communication device, hereinafter referred to as a “target device”.

### BACKGROUND

Robotic systems and Unmanned Aerial Systems (UAS) are poised to change our society in ways that have yet to be imagined.

One of the key technologies enabling autonomous use (as opposed to manually piloted) of an UAS is positioning and control. Conventionally, UAS designers have put emphasis on absolute positioning (the specific location or position of the UAS in a coordinate space), since it has generally been thought of as being instrumental to the success of mid- to high-altitude Intelligence, Surveillance, and Reconnaissance (ISR) missions where UAS's have typically been used by the military (the primary user of UAS's to date). With the proliferation of low-flying portable UAS's (e.g. multi-rotors), however, reliable relative positioning is crucial. This will enable UAS's to locate an asset or “target device” while safely operating in close proximity to and relative to other (mobile) humans and machines, for both military and civilian use.

First responders need systems that are even more autonomous than our current UAS technology. A current impediment to widespread adoption of this technology is that often the client user cannot require every employee to become a highly skilled remote-control pilot. In ideal circumstances, these robotic systems should be able to operate as “autonomously” as possible, in order to free the user so they can focus on the life safety aspects of the specific mission, instead of exclusively about operating the robotic system or UAS.

Before such first responder robotic systems and UAS's can become a reality, they should generally be able to reliable and accurate in locating a moving target, during an emergency, using traditional emergency location devices. The “defined target” which could be a person (drowning, swimming, walking, running, biking, skiing, an animal (military/search-and-rescue dog), another vehicle (a car, a truck, another robotic system or UAS), or a moving platform such as a Coast Guard Cutter, or a mostly stationary reference such as a landing pad, floating dock and other applicable landing surfaces. The Robotic system and UAS positioning/control technologies typically focus on performing these tasks in the absolute frame {i.e., with respect to fixed coordinates, and or using some form of optics and/or Computer Vision, (CV).

The focus of our work is developing radio frequency, typically on a Very High Frequency (VHF), for locating and tracking systems; for the purpose of autonomous control of robotic systems and UAS, and which is made possible by decoding embedded location specific data from radios designed for “emergency” RF signaling that is specifically based on radio technology designed for military, nautical and first responder use.

The presently disclosed navigation system addresses many of the problems and issues set forth above, thereby enabling robotic systems and UAS to be operated by personnel without exceptional piloting skills. As such, the presently disclosed system allows operators to simply designate where the robotic system or UAS is to be positioned by embedding an emergency band radio “target device” on the “defined target” or object of interest, for example a “man/woman overboard” device attached on a cruise ship passengers life jacket. Accordingly, the presently disclosed systems and methods for effectively and accurately navigating an unmanned robotic system or UAS relative to a moving target are directed to overcoming one or more of the problems set forth above and/or others set forward in the art.

### SUMMARY

A system providing reliable, highly accurate relative navigation for robotic systems and UAS, (e.g., properly equipped UGV, USV or UAV) engaged in rescue operations is the desired outcome. Systems and methods associated with the presently-disclosed embodiments enable small robotic systems and UAS to autonomously locate persons or assets through the detection of emergency Personal Locator Beacons (PLBs) or other emergency Radio Frequency (RF) communication devices, regardless of the operating and environmental conditions (urban, mountainous, day/night/and inclement weather). Systems and methods consistent with the disclosed embodiments take advantage of the mobility of the UAS to use multiple sensors, including emergency band RF signal detectors, and proprietary software to accurately resolve and control the position of the UAS relative to the “target device” and the person wearing it, the “defined target”. This system is platform agnostic and will be suitable for use on most UAV, UGV, USV and UAS, while using emergency RF beacons on the target, that are currently available on the market today.

According to one embodiment, the UAS generally consists of an unmanned radio-controlled multi-rotor aircraft, with a companion computer located onboard the UAV, which may also contain a variety of other sensors, and processes their information in our proprietary decoder and navigation software. The onboard companion computer can also leverage information from additional target devices, by utilizing a suite of sensors and a data link on the UAS. At least one “target device”, (e.g. “Man-Overboard” Signaling Device) is required for the UASTrakker system to provide a full relative tracking and navigation solution.

The presently disclosed system provides the following key attributes to any Robotic system or UAS:

(A) Autonomy: Requires little to no user input, so the user can focus on his or her task (“launch and forget”); and

(B) Availability: 1) Deployed and recovered automatically anywhere, even from moving vehicles, and 2) functions in harsh operational environments (day/night/rain/fog/smoke, etc.) for uninterrupted support to ground personnel in the real-world;

(C) Safety and reliability: Accurately locating people or moving assets, and trusted to work safely every time without user involvement or intervention.

The presently disclosed systems and methods address the navigation, guidance and control challenges by leveraging the collaborative “locating” nature of this application. The collaborative relationship between the robotic system or UAS and its “defined target” implies that the UAS may have access to both pre-configuration and real-time information about the “target device”. This data is leveraged in multi-sensor/multi-platform software environment that enables our method's resiliency regarding motion, relocation and environmental disturbances.

According to one aspect, the present disclosure is directed to a method for navigating an Unmanned Aerial System relative to a flight plan, in search of a “defined target”. The method may comprise detecting, using an emergency radio frequency detector on the airborne UAS, an emergency radio frequency signal generated by a commercially available emergency Personal Locator Beacon (PLB) or emergency transponder on the target.

The method comprises comparing, by a companion computer processor on the in-flight UAS, the detected radio frequency signal data with any previously-detected radio frequency signal data. The method further comprises determining by the companion computer and proprietary software, based on the comparison, a change in location of at least one of the Ground Control Station (GCS) or “target devices”. The method also comprises adjusting the position of the UAS based on the determined change in location(s).

According to one aspect, the present invention is directed to a method for cellular or satellite modem enabled back-up navigation command & control of an in-flight system, relative to a flight plan in search of a “target device”, using emergency RF beacons or “target device”. The method may comprise detecting an emergency radio frequency detector on the UAS, an emergency radio frequency signal generated by a commercially available emergency transponder on the “defined target”. The method comprises decoding or translating those radio signals into ASCII text data that is sent to a “Cloud Data Service” (CDS), by a modem on the in-flight system for use by our custom software platform. The translated radio frequency signal data will be compared with previously-detected radio frequency signal data onboard and within the CDS. This method further comprises alerting any operator of the CDS to a change in location of at least one of the UAS, GCS or the “target device”. The method comprises allowing the operator of the CDS to adjust the position of the UAS through the companion computer and our custom software, transmitting that instruction to the aircraft via two-way modem communication, (e.g. cellular or satellite modem), using the native flight commands for the OEM available UAS flight controller, (e.g. MAVLink for PixHawk or Erle Brain).

In accordance with another important aspect, the present disclosure is directed to a system for persistent aerial monitoring of the target(s). The system is comprised of a commercially available “target device” (e.g. Man-Overboard Device or other Emergency RF transponder, etc.) coupled to the “defined target” like a firefighter, whereas the “target device” comprises at least one transponder configured to generate an emergency Radio Frequency signal, (e.g. AIS-B) that is on the defined “target device”. The system incorporates on the UAS, a radio frequency detector (e.g. AIS-B receiver) configured to detect the radio frequency signal generated by the “target device”, and a companion computer communicatively coupled to the onboard radio frequency detector. The onboard companion computer software is configured and programmed to compare the detected radio frequency signal data with any previously-detected Radio Frequency signal data, determine a change in location of at least one of the in-flight UAS or the “target device”, and generates control signals, (e.g. MAVLink commands for a PixHawk or Erle Brain) for adjusting a position of the in-flight UAS based on the change in location.

In accordance with another important aspect, the invention is directed to a method for aerial tracking of a defined target. The method may comprise detecting, on a radio frequency detector associated with the robotic system or UAS, an emergency radio frequency signal data pattern generated by signals from a transponder associated with the target device, such as a commercially available emergency PLB.

The method also comprises comparing, by a companion computer installed on the robotic system or UAS, the detected pattern with a previously-detected radio frequency signal data pattern, and/or with a baseline data pattern such as a map of locations where prior incidents have occurred.

The method may further comprise determining, by the companion computer analysis, based on the comparison, a potential change in location of the “target device”.

### BRIEF DESCRIPTION OF THE DRAWINGS

FIG. 1A.—Illustrates a First Responder, person or asset with an emergency signaling device, in which the presently disclosed systems and methods are used for effectively and accurately navigating an Unmanned Aerial System relative to the movements of the emergency signaling device that may be implemented, consistent with certain disclosed embodiments;

FIG. 1B.—Illustrates another exemplary operating environment including a UAS and a moving “defined target” in which the presently disclosed systems and methods for effectively and accurately navigating a UAS relative to the moving person or asset are using a radio such as an emergency PLB, may be implemented, in accordance with certain disclosed embodiments;

FIG. 1C.—Illustrates another exemplary operation environment including a UAS and its Ground Control Station, (GCS), in which the presently disclosed systems and methods for effectively and accurately navigating a UAS relative to a moving defined target with a PLB may be implemented, in accordance with certain disclosed embodiments;

FIG. 2.—Illustrates a UASTrakker emergency RF tracking system, such as an Unmanned Aerial System (UAS), in accordance with certain disclosed embodiments;

FIG. 3.—Provides a diagram of components associated with a system for navigating a robotic system or UAS relative to a moving defined target with a PLB, in accordance with certain disclosed embodiments;

FIG. 4.—Illustrates a schematic diagram of a companion computer and control system in which the presently disclosed methods for navigating a UAS seeking a defined target with a PLB, are described consistent with certain disclosed embodiments.

FIG. 5.—Provides a flowchart depicting an exemplary process(es) to be performed by one or more processing devices (e.g. companion computer) associated with a system for navigating a UAS relative to a moving defined target with a PLB, in accordance with certain disclosed embodiments.

FIG. 6.—Provides a chart depicting an exemplary process(es) to be performed by one or more processing devices associated with a system for motor and Electronic Speed Controller (ESC) control on a UAS, in accordance with certain disclosed embodiments.

### DETAILED DESCRIPTION OF THE DRAWINGS

Systems and methods consistent with the disclosed embodiments are directed to solutions for tracking of a “defined target” (e.g., a person or asset) with its associated emergency RF device (e.g. PLB), hereinafter simply referred to as a “target device”, by a robotic system such as an Unmanned Aerial System (UAS), or other vehicle controlled by a robotic brain. More particularly, the processes and features disclosed herein provide a solution for allowing the Unmanned Aerial System (UAS), or a robotic system such as an Unmanned Ground Vehicle (UGV) or Unmanned Surface Vehicle (USV), to accurately and reliably follow a “target device”, while maintaining a generally constant relative distance from the target and avoiding obstacles in the path of the UAS or robotic system. Exemplary features associated with the presently disclosed system include path prediction schemes for adjusting the flight path of the UAS or robotic system during tracking of the “target device”. One or more radio frequency devices mounted on the UAS or robotic system are used for tracking of the target device, as well as cameras to record video of the defined target (e.g. injured hiker) for various uses, such as intelligence, surveillance, and reconnaissance (ISR) activities, aerial search and recovery, and/or recreational use, all autonomously, without requiring advanced user piloting activities.

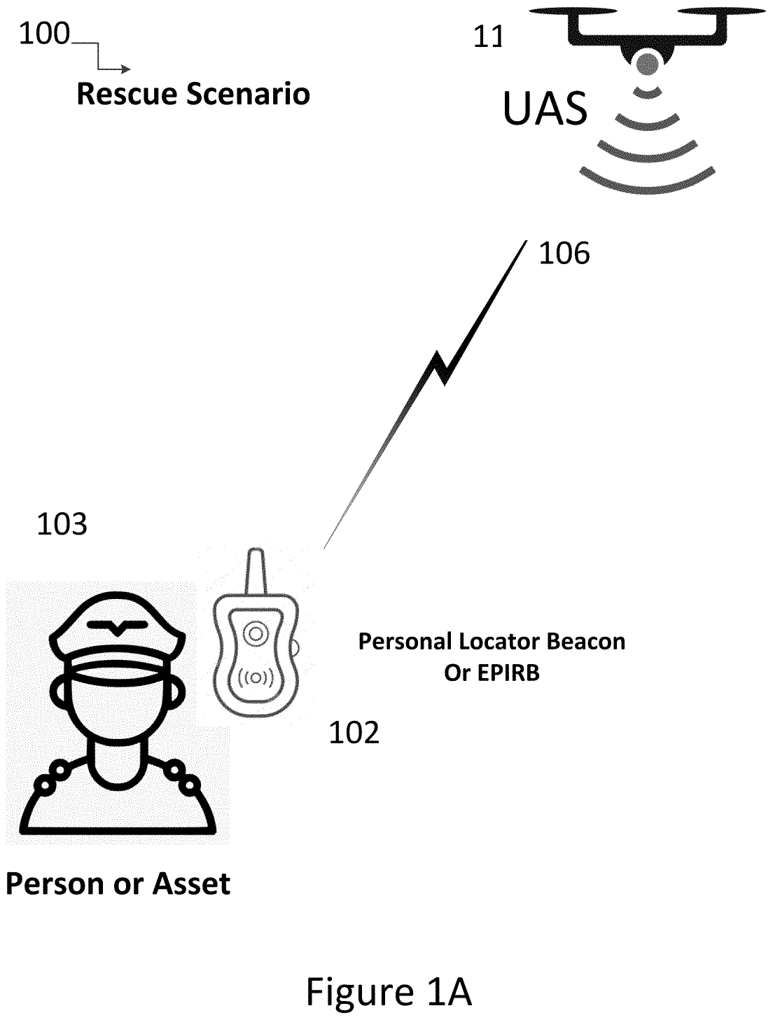

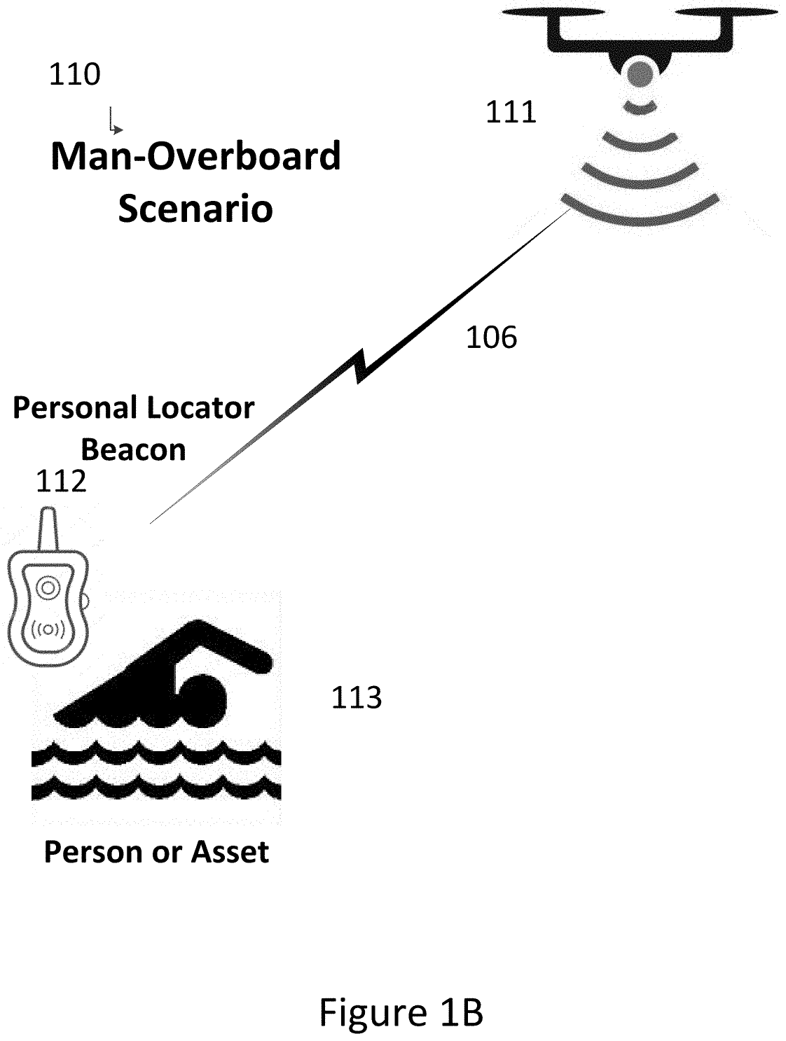

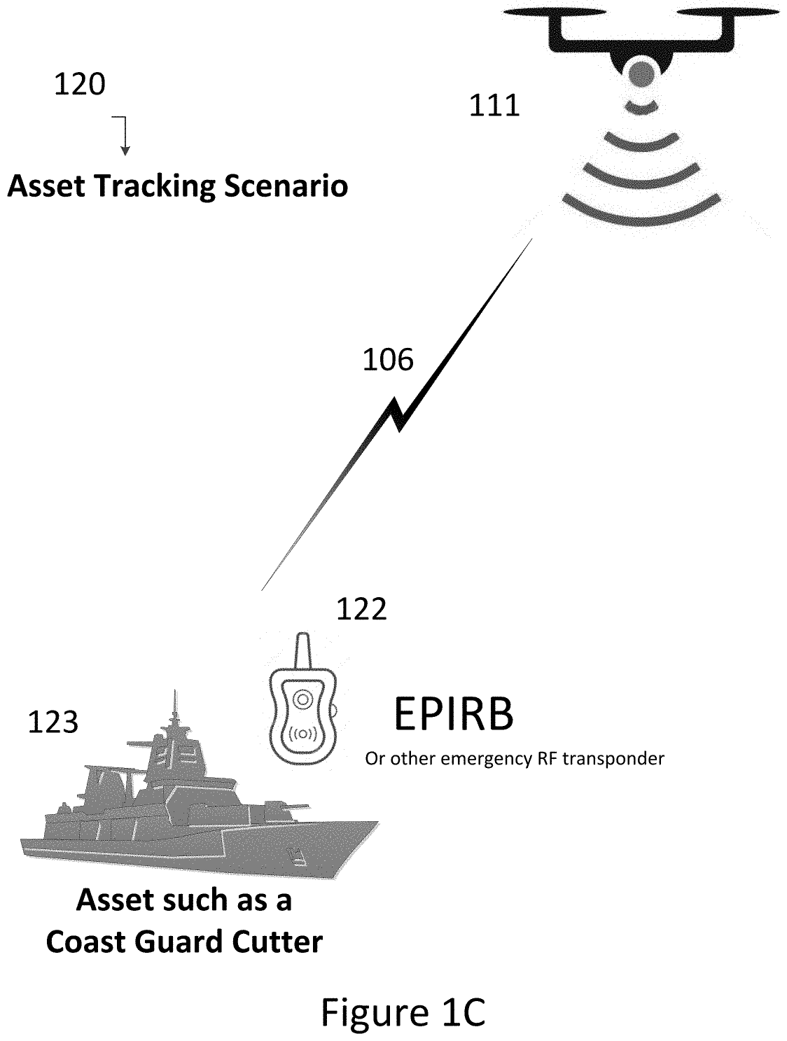

FIGS. 1A-1C.—Illustrate exemplary operational environments 100, 110, and 120, respectively, in which the presently disclosed systems and methods for effectively and accurately navigating a UAS relative to a moving target may be implemented. As illustrated in each of FIGS. 1A-1C, according to exemplary embodiments, the operational environmental scenarios 100, 110, 120 include a robotic system 111, such as a UAS and one or more stationary or moving targets. 103, 113, 123. In certain embodiments UAS 111 is communicatively signaling via a data link 106 to one or more “target” devices that may be mounted or otherwise attached to target 103, 113, 123. As illustrated in FIG. 1A, and will be explained in greater detail in connection with the figures and flowcharts that follow, in-flight vehicle 111 may be configured to track targets 102, 112, 122 from an aerial flight position along a predetermined flight path.

The presently disclosed system is designed to be integrated into an existing UAS in order to transform them into a Professional UAS that is more intelligent while acting autonomously. As illustrated in FIG. 1B, the system generally comprises two parts;
1. The UAS with system “target devices” (which includes but is not limited to emergency RF radios and an onboard companion computer system) and;
2. a “defined target” who is carrying an emergency Radio Frequency (RF) Personal Locator Beacon (PLB) type device 112.

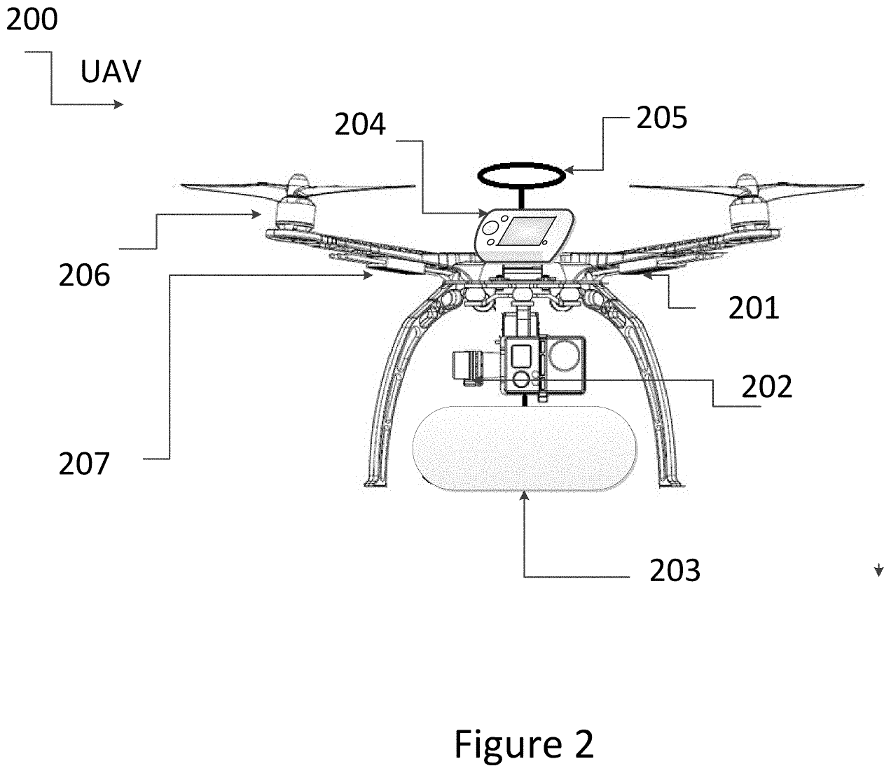

The system components (illustrated in FIG. 2) are mounted on UAS 111, as illustrated in FIGS. 1A-1C in a location that enables it to have an unobstructed radio range of the person or asset 103, 113, 123. The target device 102, 112, 122 is mounted on the person or asset 103, 113, 123 and is typically a VHF Emergency Radio Frequency (RF) Personal Locator Beacon (PLB), broadcasting on an emergency radio frequency {e.g. 161.975 MHz (AIS-1, or VHF channel 87B) and 162.025 MHz (AIS2, or VHF channel 88B), 406 MHz, etc.} but there may be other wavelengths of radio frequency or satellite signals that are contemplated to be distributed by the target device as shown in FIGS. 1A-1C; 102, 112, 122.

FIG. 2 illustrates a multi-rotor Unmanned Aerial System (UAS) 200, in accordance with certain disclosed embodiments. As illustrated in FIG. 2, the UAS may be comprised one or more electrical components adapted to control various aspects of the operation of the UAS, which may be installed inside a housing or cavity associated with the UAS, or mounted to the UAS such as on the underside of the aircraft. Such electrical components can include an energy source (e.g., battery), flight control or navigation module, GPS module (e.g., GPS receivers or transceivers), Inertial Measurement Unit (IMU) module, communication module (e.g., wireless receiver), Electronic Speed Control (ESC) module 207 adapted to control an actuator (e.g., electric motor) 206, such as an electric motor used to actuate a rotor blade or rotor wing of the UAS, as well as electrical wirings and connectors used to build the system.

In some embodiments, some of the electrical components are located on an integrated electrical unit such as a circuit board or module. One or more electrical units may be positioned inside the housing of the robot or airborne vehicle 201. When in use, the electrical components discussed herein may cause interference (e.g., electromagnetic interference) to other components 205 (e.g., magnetometer) of the UAV. In some embodiments, the interference may be caused by ferrous material or static sources of magnetism. For example, the electrical components may be comprised of magnets that generate magnetic fields, thereby causing magnetic interference. The design of the completed Unmanned Aerial System (UAS) is built to address such concerns.

As illustrated by FIG. 2, the body or frame portion of the Unmanned Aerial Vehicle (UAV) 201 comprises a central housing member and one or more branch housing members. The inner surface of the central housing member can form a central cavity. Each of the branch housing members, in the shape of a hollow arm or any other suitable shape, can form a branch cavity. When the central housing member is connected to the one or more branch housing members, the central cavity and the one or more branch cavities can collectively form one unified cavity.

The branch housing members can be connected to the central housing member in an “X” or star shaped arrangement. Specifically, when a multi-rotor aircraft is used, the central housing member can be located at the center of the X or star shaped arrangement whereas the branch housing members can be equally distributed around the central housing member, in a symmetric or asymmetric fashion. In some embodiments, such a hub and spoke arrangement can facilitate efficient electrical connection between electrical components disposed within the cavity of the housing, such as between a centrally located flight control module and the individual ESC modules located in respective branch cavities. Or between a centrally located energy source (e.g., battery) and actuators (e.g., electric motors) used to drive the rotors of the multi-rotor UAV. In other embodiments, the housing and/or the cavity inside the housing of the UAV may have a shape other than the hub and spoke described herein. For example, the housing and/or the cavity inside the housing can form a substantially spherical, elliptical, star or cylindrical shape or any other shape.

In a typical embodiment, the number of branch housing members is equal to the number of rotors or actuator assemblies of the UAV. An actuator assembly can include a rotor wing or rotor blade and an actuator that is used to actuate the rotor blade. For example, a four-rotor UAV as illustrated in FIG. 2 may have four branch housing members, each corresponding to one of the four rotors or actuator assemblies. In the illustrated embodiment, the UAV has four branches, each corresponding to one actuator assembly. That is, the UAV has four actuator assemblies. In various embodiments, the number of the branches and/or the arrangement thereof may be different from those illustrated herein. For example, in some embodiments, there may be more or less branch housing members and/or rotors or actuator assemblies than illustrated here. For example, a six-rotor UAV may have six rotors or actuator assemblies and six corresponding branch housing members. An eight-rotor UAV may have eight rotors or actuator assemblies and eight corresponding housing members. In alternative embodiments, the number of branch housing members may not correspond to the number of rotors or actuator assemblies of the UAV. For example, there may be more or less branch housing members than actuator assemblies. In various embodiments, the numbers of branches, actuator assemblies, and actuators can be adjusted according requirements of actual circumstances. To ensure stability of the UAV during operation, a typical multi-rotor UAV has no less than three rotors.

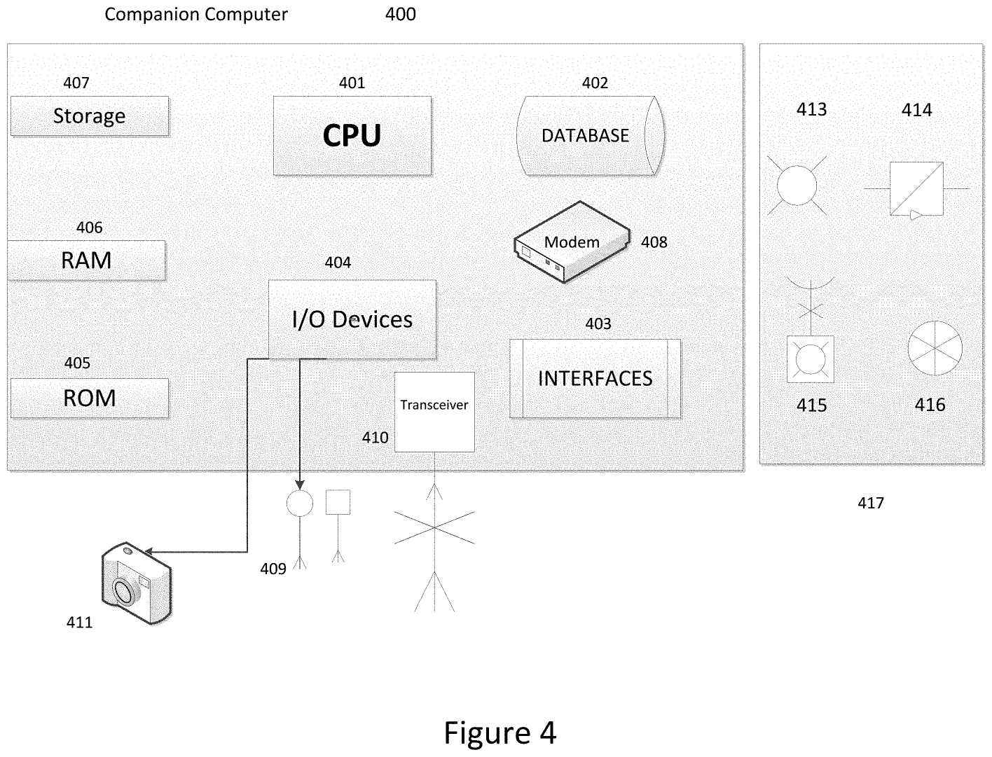

In some embodiments, some of the electrical components discussed above may be located on one or more circuit modules. Each circuit module can include one or more electrical components. For example, as shown in FIG. 4, the circuit module can include the main flight control module that includes one or more processors such as implemented by a Field-Programmable Gate Array (FPGA) for control and operations of the UAV. As another example, the same or a different circuit module can also include an IMU module for measuring the UAV rotational rate, and acceleration. The IMU module can include one or more accelerometers and/or gyroscopes. As another example, the same or a different circuit module can also include a communication module for remotely communicating with a target device. For example, the communication module can include an Emergency VHF transceiver.

The flight control module, or “main processor”, is typically a key component or the primary computer of an Unmanned Aerial System (UAS). For example, the flight control module can be configured to estimate the current velocity, orientation and/or latitude and longitude position of the UAS based on data obtained from onboard sensors like the compass, IMU, GPS receiver for performing path planning, providing control signals to actuators to implement navigational control. As another example, the flight control module can be configured to respond to control signals to adjust the position of the UAS based on remotely received control signals.

In some embodiments, the electrical components can include one or more Electronic Speed Control (ESC) modules. An ESC module can be adapted to control the operation of an actuator. The actuator is a part of an assembly configured to adjust a wing flap or rotate a rotor blade of the UAS. In some embodiments, the ESC module can be electrically connected to the flight control module on the one hand, and an actuator on the other hand. The flight control module can provide control signals for the ESC module, which in turn provides actuator signals to the electrically connected actuator so as to rotate the corresponding rotor blade. In some embodiments, feedback signals can be provided by the actuator and/or the ESC module and sent to the flight control module.

In some embodiments, the UAV includes one or more connecting members for electrically coupling or connecting the various electrical components of the UAV. Such connecting members can include electrical wires, cables, etc. that are used for transmitting power, data or control signals between the components. For example, the connecting members can be used to electrically connect 1. an energy source and an actuator assembly; 2. a circuit module and an ESC module; 3. an ESC module and an actuator; 4. a communication module and a circuit module. In some embodiments, the connecting members have pluggable connectors at their distal portions to facilitate plugging and unplugging of the connecting members with respect to the electrical components.

In some embodiments, some or all of the electrical components discussed above are pre-configured, pre-assembled or pre-connected by the OEM manufacturer of the UAV. In such embodiments, no or very little user assembly and/or calibrate may be required for the UAV to operate, making the UAV “ready-to-fly” out-of-the-box. Such pre-configuration of components not only enhances the user experience by lowering the technical expertise required, but also reduces the errors or accidents caused by a user's mis-configuration. In some embodiments, such pre-configured or pre-assembled components can include the flight control module, GPS receiver, ESC module, or any of the electrical components discussed herein, or any combination thereof. In some embodiments, one or more electrical components may be pre-configured, pre-connected or pre-assembled as an electrical unit (e.g., a circuit module). The electrical unit may be necessary and sufficient for controlling operation of the UAV. In some embodiments, no additional user configuration is required for the pre-configured components to operate properly out-of-the-box.

In other embodiments, some amount of user configuration or assembly may be required. In other situations, the user may define certain parameters, such as flight altitude and range between the robotic system or UAS 111 and a person or asset 113 from a set of pre-selected parameters.

As illustrated in FIG. 1C, the UAS may be communicatively paired to a “target device” and may be configured to receive, process, and/or analyze data measured by the target device 122. According to one embodiment, the UAS 111 may also be wirelessly coupled to a person or asset 123 via alternate respective wireless communication transceiver(s) 122 operating any suitable protocol for supporting wireless (e.g., Cellular modem, Wi-Fi or Satellite modem)

According to other embodiments, wireless communication transceivers 122 may embody an integrated wireless transceiver chipset, such as Bluetooth, Wi-Fi, NFC, or 802.11x wireless chipset included as part of the respective “companion computer system” of the UAS 111 or target device 112.

System Configuration

FIG. 2 illustrates an exemplary embodiment of devices that are used in the presently disclosed systems for effectively and accurately navigating an Unmanned Aerial System (UAS) relative to a moving target.

Processing hardware 204 associated with UAS 200 may include or embody any suitable microprocessor-based device configured to process and/or analyze information collected by emergency Radio Frequency (RF) sensors associated with the respective system.

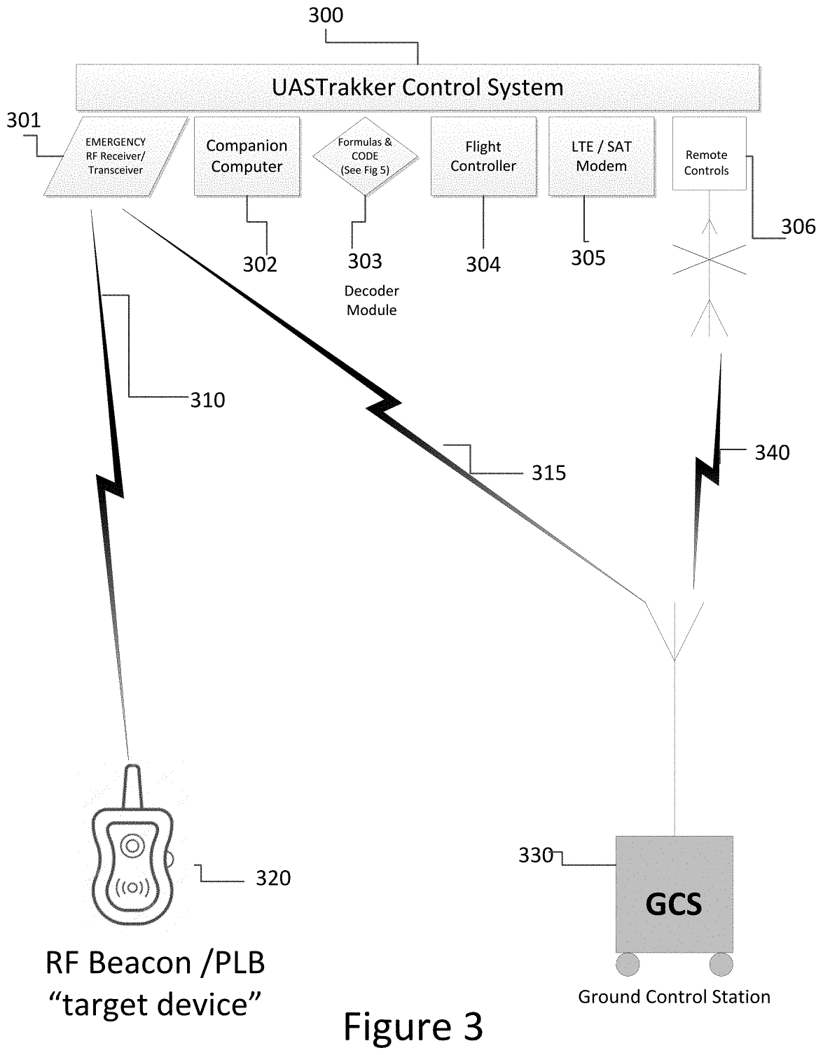

FIG. 3 illustrates an exemplary embodiment of components that are used in the presently disclosed systems for effectively and accurately navigating a UAS relative to a moving target, by use of an emergency Radio Frequency receiver or transceiver 301.

According to one embodiment, the UASTrakker Control System 300 may embody a general-purpose computer, (companion computer) programmed with software for receiving and processing RF signals; (for example, determining position information associated with the corresponding component of the system.)

According to other embodiments, processing hardware 302 may be a special-purpose computer or Application-Specific Integrated Circuit (ASIC) to perform specific processing tasks (e.g., range detection, path prediction, obstacle detection, or collision avoidance). Individual components of, and processes/methods performed by, flight controller 304 will be discussed in more detail below in connection with the explanation of the operational code and methods.

FIG. 3 illustrates an exemplary embodiment of emergency RF radio equipment that is used in the presently disclosed systems for effectively and accurately navigating an UAS relative to a moving target. GCS 330 uses traditional radio signals for UAS hand controls 340, and emergency band RF for rescue operation signals 315. Target device 320 uses an emergency Personal Locator Beacon or other emergency transceiver to transmit its location 310. Aircraft picks up both locations using it's onboard emergency RF receiver or transceiver 301.

According to the embodiment illustrated in FIG. 3, both the in-flight UAS 300 and target device 320 have one or more inertial measurement units (IMUs), static pressure sensors, tri-axial magnetometers, and/or GPS receivers.

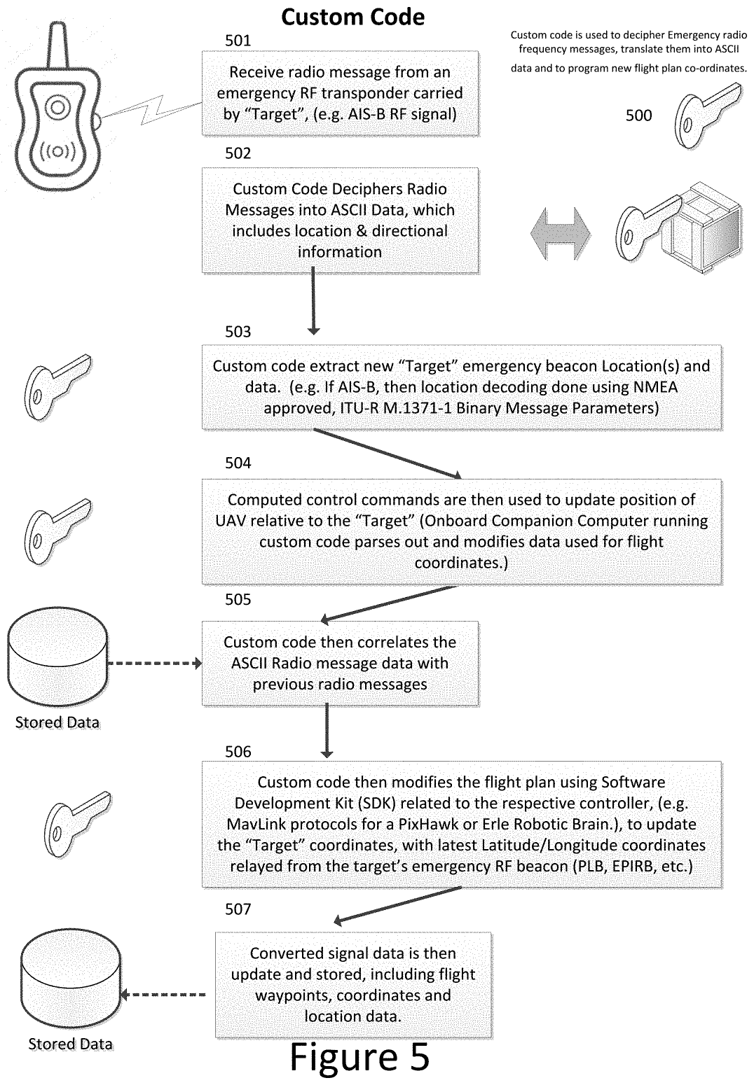

According to the embodiments illustrated in FIG. 3, custom formulas and software code 303 are used to decipher the embedded ASCII data from an emergency RF signal transmission, yielding the specific location data being transmitted from a Personal Locator Beacon (PLB) or other type of emergency RF signaling device. See FIG. 5 for a detailed description of this process.

As illustrated in FIG. 4, the UAS's companion computer 400 may be integrated with one or more Emergency RF radios or transceivers 410, each of which is configured to detect radio frequency signals emitted by a PLB that is associated with a person or asset. The embodied UAS may include one or more range sensors 412, interfaces 403 are configured to detect the range sensors (e.g. flow camera, LIDAR or SONAR) that are configured to detect the relative distance between the UAS and target device. Raw data from all sensors is provided to our proprietary software, where it can be merged and analyzed to estimate the relative state, and compute guidance commands that are sent to the UAS autopilot using its native code base, (such as Mav-Link for a PixHawk or Erle brain) to perform course adjustments, (e.g. pitch, roll, yaw, thrust).

As explained, a processor associated with the robot or UAS may be configured to control a motor or actuator associated with the UAS in order to make modifications to the position of the UAS relative to changes in the position of the emergency RF device carried by the person or asset (hereinafter referred to as “defined target”). The position of the UAS may then be adjusted to maintain a hover at the desired relative position and/or distance between the UAS and the “target device”.

Radio, Sensor and Data Integration

FIG. 4 illustrates a schematic diagram of a companion computer system 400, in which the presently disclosed methods for navigating a UAS relative to a moving “defined target” takes place, consistent with certain disclosed embodiments. The companion computer system 400 is included as part of UAS or payload, and may include additional or different computer components than those illustrated in FIG. 4. For example, Database 402, Storage 407 and Modem 408 may be omitted from the target device payload in order to reduce size, weight, and cost of the device. Essentially, FIG. 4 serves to illustrate the exemplary (and optional) hardware that may be used in performing the data processing and analysis that is generally associated with the in-flight UAS.

As explained, the companion computer system 400, associated with a Robotic system or UAS may be any processor-based computing system that is configured to receive sensor information from the emergency radio transponder carried by the target device and/or core sensor package 412, calculate the relative position of one or more of the UAS or target, analyze the relative position information, and adjust the position of the robotic system or UAS in order to track the target and maintain a relative distance between the robotic system or UAS and the target device. Non-limiting examples of such a companion computer system may include a desktop or notebook computer, a tablet device, a smartphone, wearable or handheld computers, ASIC, or any other suitable processor-based computing system. As illustrated in FIG. 4, core sensor package 412 may include a GPS 413, IMU 414, magnetometer 415, and/or range sensors 416 as examples.

For example, as illustrated in FIG. 4, companion computer system may include one or more hardware and/or software components configured to execute and process data, such as range finding, collision avoidance, obstacle detection and path planning. According to one embodiment, the companion computer system may include one or more hardware components such as, for example, a Central Processing Unit (CPU) or microprocessor 401, a Random-Access Memory (RAM) module 406, a Read-Only Memory (ROM) module 405, a memory or data Storage module 407, a Database 402, one or more Input/Output (I/O) devices 404, and an interface such as Bluetooth or USB 403. Alternatively, and/or additionally, companion computer system may include one or more software media components such as, for example, a “computer-readable” medium including computer-executable instructions for performing methods consistent with our disclosed embodiments. It is contemplated that one or more of the hardware components listed above may be implemented using configuration software. For example, Storage 407 may include a software partition associated with one or more other hardware components of companion computer system. It is understood that the components listed above are exemplary to the solution, and not intended to be limiting in nature.

CPU 401 is the heart of the companion computer system and may include one or more processors, each configured to execute instructions and process data to perform one or more functions associated with companion computer system 400. As illustrated in FIG. 4, CPU 401 may be communicatively coupled to Database 402, interface 403, I/O Devices 404, ROM 405, RAM 406 and storage 407. CPU 401 may be configured to execute sequences of computer program instructions to perform various processes, which will be described in FIG. 5. The computer program instructions may be loaded into RAM 406 for execution by CPU 401.

ROM 405 and RAM 406 may each include one or more devices for storing information associated with an operation of Companion Computer system and/or CPU 401. For example, ROM 405 includes a memory device configured to access and store information associated with companion computer system, including information for identifying, initializing, and monitoring the operation of one or more components and subsystems of companion computer system. RAM 406 typically includes a memory device for storing data associated with one or more operations of CPU 401. For example, ROM 405 may load instructions into RAM 406 for execution by CPU 401.

Storage 407 typically includes any type of mass storage device configured to store information that CPU 401 will need to perform processes consistent with the disclosed embodiments. For example, storage 407 could include one or more magnetic or disk devices, such as hard drives, CD-ROMs, DVD-ROMs, or any other type of mass media device. Storage 407 may include flash memory mass media storage or other semiconductor-based storage medium. Alternatively, or additionally, storage 407 may include internet cloud-based storage or access to private “on-premise” server.

Database 402 may include one or more software and/or hardware components that cooperate to store, organize, sort, filter, and/or arrange data used by companion computer system and/or CPU 401. For example, Database 402 may include historical data such as, for example, stored PLB route data that is used for route estimation. CPU 401 may also analyze current and previous path coordinates or parameters to identify trends in historical data. These trends may then be recorded and analyzed to allow the airborne UAS to more effectively navigate. It is contemplated that database 402 may store additional and/or different information than that listed above.

I/O Devices 404 may include one or more components configured to communicate information with a user associated with system. For example, I/O devices may include a console with an integrated keyboard, monitor and mouse to allow a user to input parameters associated with companion computer system. I/O devices 404 may also include a display including a Graphical User Interface (GUI). I/O devices 404 may also include peripheral devices such as, for example, a printer for printing information associated with companion computer system, a user-accessible disk drive (e.g., USB port, a floppy disk, CD-ROM, or DVD-ROM drive, etc.) to allow a user to input data stored on a portable media device via a microphone, a speaker system, or any other suitable type of interface device. According to one embodiment, I/O Devices 404 may be communicatively coupled to one or more cameras 415 and range finding devices in order to assist in locating “target”, and/or detecting radio frequency information transmitted by the PLB associated with target (“associated” means that the target is usually a person or asset that is carrying the emergency RF device, such as a PLB).

Interface 403 may include one or more components configured to transmit and receive data via a communication network, such as the Internet, a local area network, a peer-to-peer network, a direct link network, a wireless network, or any other suitable communication platform. For example, interface 403 may include one or more modulators, demodulators, multiplexers, de-multiplexers, network communication devices, wireless devices, antennas, modems, and any other type of device configured to enable data communication via a communication network. According to one embodiment, interface 403 may be coupled to or include wireless communication devices, such as a module or modules configured to transmit information wirelessly using Wi-Fi or Bluetooth wireless protocols. Alternatively, or additionally, interface 403 may be configured for coupling to one or more peripheral communication devices, such as an LTE Cellular modem, or satellite modem.

FIG. 5 illustrates one of the most important aspects of our invention. It provides a flowchart depicting an exemplary process to be performed by one or more processing devices, using our custom detection and decoding software for navigating an UAS relative to a moving person or asset which is carrying an emergency RF PLB, hereinafter referred to as the target, in accordance with certain disclosed embodiments.

It should be apparent to those skilled in the art that various modifications and variations can be made to the disclosed systems and methods for effectively and accurately using emergency band radio frequency signal data to navigate an unmanned robotic system or UAS relative to a moving target. Other embodiments of the present disclosure will be apparent to those skilled in the art from consideration of the specification and practice of the present disclosure. It is intended that the specification and examples be considered as exemplary only, with a true scope of the present disclosure being indicated by the following claims and processes.

These processes are included as part of our software solution, and may include additional and/or different processes than those illustrated in FIG. 5. For example, message receipt 501, deciphering 502 and location assessment 503 are, in this example, based on the radio band selected, (e.g. AIS-B), having embedded data in the radio transmission, as opposed to just a tone being detected by the UAS. An RF radio using a different band, such as 121.5 Mhz, which emits only a tone, would require entirely different processes to track.

FIG. 5 serves to illustrate the exemplary processes that may be used in performing the data processing and analysis that is associated with autonomous flight of the UAS. It should be understood, however, that, given the collaborative nature of the system, in addition to radio band limitations, some or all of these processes may be included or omitted. It will be based upon the customers application, so for example the data to cloud services might be included, or omitted.

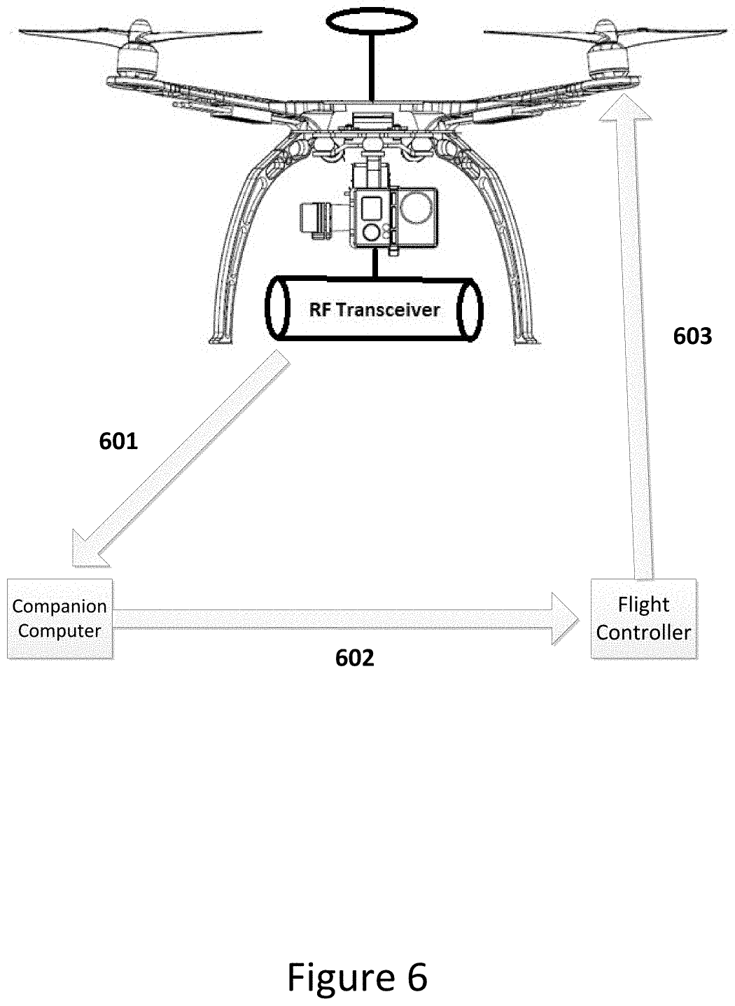

FIG. 6 provides a flowchart depicting an exemplary process to be performed by one or more processing devices, using our proprietary system for navigating an UAS relative to a moving target, in accordance with certain disclosed embodiments. For example, a target's RF beacon message is delivered from the onboard RF receiver or transceiver to the onboard companion computer 601, then the companion computer deciphers the location of the target device or beacon, creates a flight command and delivers it to the onboard flight controller 602, which then sends the appropriate electrical impulses to the motors and electronic speed controllers (ESC's) that drive the UAS or robotic system. This autonomous process relieves the pilot in control of the necessity to constantly correct the flight path of the UAS, relative to the target device and the person in distress.

While this specification contains many specific implementation details, these should not be construed as limitations on the claims. Certain features that are described in this specification in the context of separate implementations may also be implemented in combination in a single implementation. Conversely, various features that are described in the context of a single implementation may also be implemented in multiple implementations separately or in any suitable sub combination. Moreover, although features are described above as acting in certain combinations and even initially claimed as such, one or more features from a claimed combination may in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

It will be apparent to those skilled in the art, that various modifications and variations can be made to the disclosed systems and methods for effectively and accurately using emergency band radio frequency signal data to navigate an unmanned aerial vehicle relative to a moving target. Other embodiments of the present disclosure will be apparent to those skilled in the art from consideration of the specification and practice of the present disclosure. It is intended that these specifications and examples be considered as exemplary only, with a true scope of the present disclosure being indicated by the following claims and their equivalents.

### INDUSTRIAL APPLICABILITY

By integrating the presently disclosed relative navigation system into an existing robotic system or UAS, the robot or UAS can be transformed into a First Responder UAS that autonomously assists professionals in “real-time” through its onboard payload.

In certain scenarios the VHF radio signal data, and raw video feed, may need to be converted into actionable data for the user, similar to military systems available today. It is contemplated that emergency radio frequency data processing can be used to interact with a commercially available onboard video system to extract features of interest (e.g. objects in danger) using LIDAR or Artificial Intelligence (AI) enabled Computer Vision (CV) or may be used to automatically alert the user during the performance of a mission (police patrol or pursuit, search-and-rescue operation, etc.). In addition to being downlinked to a centralized ground control station, the video and data feeds from the UAS can be streamed directly to a cloud computing solution, enabling online multi-agency collaboration.

Furthermore, the said invention is a collaborative relationship facilitated by the bi-directional communication between the systems that are mounted on the UAS and the target devices mounted on the defined target or persons, which ensures that the UAS has access to both initial configuration and real-time information about its operator and the defined target, including any new location data. For example, sensor data obtained by the UAS from the target device may be used to (1) locate a person or asset in danger, with high-accuracy and low-latency, (2) increase response time in a Search and Rescue (SAR) UAS navigation and machine operation, (3) provide robustness to varying environmental conditions such as an avalanche, and/or (4) provide a method of landing the UAS on a moving platform, such as a moving Coast Guard Cutter.

By exploiting the collaborative and emergency tracking nature of our software and hardware systems integration, our system provides UAS's with the accuracy and bandwidth necessary to accelerate emergency situational awareness, while (1) being able to withstand most aggressive environmental disturbances such a tropical storm or forest fire while (2) improving operational awareness and success, making it ideally suited for emergency responders and other applications involving location and tracking, (e.g. Coast Guard, Forestry, Military). Key benefits of our approach compared to current “state-of-the-art” methods include: (1) designed for rescue missions or asset monitoring applications with robustness to locating a VHF emergency Personal Locator Beacon (PLB) or similar “target device”; (2) designed for the “real-world” with robustness to varying environmental conditions like the aftermath of a storm, and; (3) high-accuracy, high-bandwidth navigation information that allows for tight UAS flight control, while abiding to FAA laws and governance; (4) while at the same time providing high-availability of the navigation solution while in flight.

### Glossary of Terms and Acronyms

AIS—Automatic Identification System

CPU—Central Processing Unit

EPIRB—Emergency Position Indicating Radio Beacon

ESC—Electronic Speed Controller

GCS—Ground Control Station

GPS—Global Positioning Satellite

IMU—Inertial Measurement Unit

I/O Device—Input and/or Output Device

ISR—Intelligence, Surveillance and Reconnaissance

PLB—Personal Locator Beacon

RAM—Random Access Memory

RC—Radio Controlled

RF—Radio Frequency

ROM—Read Only Memory

SAR—Search and Rescue

UAS—Unmanned Aerial System

UGV—Unmanned Ground Vehicle

USV—Unmanned Surface Vehicle

UAV—Unmanned Aerial Vehicle

VHF—Very High Frequency

What is claimed is:

1. A method for navigating a robotic system such as an Unmanned Ground Vehicle (UGV), Unmanned Surface Vehicle (USV), or Unmanned Aerial Vehicle (UAV) autonomously locating an emergency band Radio Frequency (RF) transmitter which is attached to an asset, (such as an AIS equipped “Man Overboard” device attached to a person who falls overboard from a ship). The method asserts for the purpose of this claim, the person who falls overboard is the (“Defined Target”), and the Emergency band RF transmitter they are carrying is the (“Target Device”) which may also be collectively referred to as the “Target”.

2. The method of claim 1, wherein adjusting the position of the robotic system or UAS includes adjusting the position of the robotic system or UAS to locate a personal locator beacon, man-over-board device, AIS, EPIRB or Military Asset Radio Frequency device, using the respective radio frequency, {e.g 121.5 MHz, 161.975 MHz (AIS-A, or VHF channel 87B) and 162.025 MHz (AIS-B, or VHF channel 88B), 406 MHz, etc.}.

3. The method used assumes that the “Defined Target” may be stationary and/or moving at different periods during a rescue operation, so any future reference to any moving target is to be considered the same as the “Target”.

4. The method used is referencing the use of an autonomous system complete with a Vehicle, a Robotic brain or flight control computer and at least one more computer on board for data processing, along with an array of sensors. It should be understood that, In the drone industry, a UAV coupled with data networks and the proper electronics may be referred to as an Unmanned Aerial System, (UAS). In the robotic industry, a UGV or USV that is coupled with data networks and the proper electronics may be also collectively be referred to as a Robotic system or Autonomous Robotic system.

5. The method of claim 4, wherein the robotic system or UAS comprises at least one motor that is communicatively coupled to the flight control processor, (e.g., Erle Brain or Pixhawk Flight Controller) on the robotic system or UAS, and configured to operate in response to the control signal generated by the flight control processor.

6. The method being used provides autonomous navigation to the robotic system Brain or UAS Flight Controller, relative to a “target device” location by detecting, on any emergency band RF signal detector (e.g. receiver, software defined radio or transceiver) attached to the robotic system or UAS, a signal generated by any GPS enabled emergency radio frequency (RF) signal emitter (e.g. man-overboard device or a GPS enabled emergency personal locator beacon) attached to the “defined target” in distress.

7. The method described in claim 6 relies on our custom software descrambling “real-time” data that is embedded within an Emergency RF Signal transmission into a specific ASCII string format, by using a second computer that is connected to the Robotic system Brain or UAS flight controller and an RF signal detector, (the second computer is hereinafter referred to as a “Companion Computer” because it is not the primary computer board on the unmanned system), to decipher the core ascii data that is embedded in the RF transmissions; which usually includes GPS coordinates of the defined Target.

8. The method does not use “sourcing” (or triangulating RF signals to locate a signal source), but rather it decodes the data that is embedded within the RF transmission, which has been specifically tailored to indicate emergency response information from an emergency radio frequency signal emitter attached to the target; (such as maritime data from an AIS Transponder on a ship, which includes a lot of valuable data like the current GPS coordinates for latitude and longitude, whether or not it is in distress, the size of the vessel or target, directional heading, temperature, etc.).

9. The method described in claim 8 allows for the encrypted data from an emergency RF transmission to be gathered instantly, decoded and utilized without triangulating or measuring signal strength from the transmitter or source, which is why our method differs from prior beacon or signal tracking technologies.

10. The method compares, by using custom software on the Companion Computer attached to the robotic system or UAS, and equipped with an RF signal detector, any detected Emergency RF signal with any previously-detected signals or waypoints*, and calculating, using the companion computer, a change in the location of the “target device”. *(Previously detected means that the operator of the robotic system or UAS may already have prior Emergency radio signal data, complete with GPS co-ordinates, indicating where the target device was when it initiated it's first or subsequent distress RF transmissions.)

11. The method adjusts the position (physical location) of the Robotic system or UAS by using the native code and control commands (e.g. MAVLink for PixHawk or Erle Brain) for the robotic brain or flight controller onboard that system to issue a new GPS waypoint coordinate. (Waypoint is an aviation term for a Latitudinal and Longitudinal specific Location, that will be traveled to by the robotic system or UAS).

12. The method of claim 10 is, in part, based on the determined change in the location of the target, which causes the robotic system or UAS to stop following the predetermined flight path that was designed, based upon a previously known location and switches to use the embedded emergency radio frequency broadcast data collected to help locate the “Target”, once it is within radio range.

13. The method of claim 11, where the robotic system or UAS incorporates an additional onboard computer or circuit board (companion computer), running Linux OS and the requisite software, (like MAVLink if flight controller is a PixHawk) so onboard Flight control software can be utilized.

14. The method of claim 11 uses a transponder or RF receiver onboard the properly equipped UAS, which uses an emergency RF signal detector to detect one of the VHF frequencies typically used for Military or Civilian navigation, and in particular emergency location communication; such as an emergency PLB, EPIRB, or devices used for maritime rescue, such as an automatic identification system (AIS) or other “man overboard beacon” or “target device”, which then submits new flight coordinates to the flight controller and instructs it to “hover” at a predetermined altitude between the robotic system or UAS and the “target device” using proprietary software which is running on the onboard companion computer while in flight. The proprietary software uses the robotic system sensors and accumulated data to keep updating records of the path traversed by the “target device”.

15. The method used can provide for valuable situational awareness data to be delivered over modem communication; thus, enabling cloud services via an application, (such as a Microsoft Xamarin application for an Apple iPhone displaying “real-time” data through Microsoft Azure Cloud Services) delivering that data simultaneously to multiple first responders. This method involves custom software being further configured to simultaneously detect other emergency radio frequency beacons (“additional target devices”) physically attached to first responders (“defined targets”) in the area, decode the embedded data, then relay the coordinates of the other active (turned on) target devices; which in turn, sends the detected telemetry data through the Cloud (in our example, Microsoft Azure enabled cloud services that retains our data) using wifi or modem communications.

16. The method used can provide “up-to-date” coordinates for the GCS for landing purposes, if the GCS uses a transponder, PLB or similar; such as when the GCS is on a moving emergency response vessel like a Coast Guard Cutter along with a “target device”. (The robotic system or UAS is simply dispatched to hover within a few feet of whichever target beacon or GCS location is selected, and which location may be constantly changing.) This method comprising receiving, in the companion computer and/or the processor attached to the robotic system or UAS, data from at least one emergency PLB, transponder or other emergency radio frequency sensor located on the moving ground control station, information indicative of at least one of a position, a rotation, an orientation, an acceleration, a velocity, or other identifying information associated with the Ground Control Station that is located on the moving vessel, such as a Coast Guard cutter.

17. The method of claim 16 is relevant because not all GCS are connected to modems or GPS when deployed on a vessel or moving platform, but a GPS enabled transponder would offer an alternative way to locate the GCS when it is stationed on a moving platform.

18. The method of claim 6, further comprising receiving and decoding, in the companion computer and/or processor associated with the Robotic system or UAS, from at least one of the aforementioned RF sensor devices located on-board the target, information indicative of at least one of a position, a rotation, an orientation, an acceleration, a velocity, or an altitude associated with the target. (e.g. one example would be using the NMEA 0183 standard for decoding AIS-B messages, our system leverages the simple ASCII, serial communications protocol that defines how data is transmitted over AIS-B emergency radios and what is decoded.)

19. The method of claim 6, further comprising comparing a pattern, (one that shows the starting waypoint, and subsequent waypoints used to track a “target device” which were defined by the previously detected emergency radio frequency signals on the current mission) with a previously-detected pattern that shows the starting waypoint, and subsequent waypoints previously used to track a target device, and which pattern may be created from a historical data source.

20. The method of claim 6, further comprising: determining that if the “target device” is not detected, or signal is lost; it will responsively revert to the previously programmed path or flight path of the robotic system or UAS; It will cause the robotic system or UAS to follow the otherwise predetermined flight plan.

21. The method creates a system for persistent surveillance of a target, including an asset and an RF device, (e.g. at least one standard emergency radio frequency transmitter, PLB or transponder configured to generate an emergency radio frequency signal), and a properly equipped robotic system or UAS By responsively adjusting the flight path of the robotic system or UAS to cause the robotic system or UAS to monitor the path traversed by the target at a safe distance, it will provide situational awareness and/or life safety awareness and support options to the rescue operators.
